(19) United States
(12) Patent Application Publication
(10) Pub. No.: US 2012/0166717 A1
(43) Pub. Date: Jun. 28, 2012

(54) Data Storage Device and Operation Method Thereof

(75) Inventors: Wen-Po LIN, Hsinchu City (TW); Hsu-Ping OU, Zhubei City (TW)

(73) Assignee: SILICON MOTION, INC., Jhubei City (TW)

(21) Appl. No.: 13/337,955

(22) Filed: Dec. 27, 2011

(30) Foreign Application Priority Data
Dec. 28, 2010 (TW) 99146318

(51) Int. Cl. G06F 12/02

(52) U.S. Cl. 711/103; 711/E12.008

(57) ABSTRACT

In one embodiment, a data storage device comprises a first flash memory, a second flash memory, and a controller. The first flash memory stores a first data shaping driver, wherein the first data shaping driver performs a data shaping function. The second flash memory stores user data. The controller enables the first flash memory and disables the second flash memory after the data storage device is turned on, detects whether a second data shaping driver has been installed on a host when the host is connected to the data storage device, installs the first data shaping driver to the host as the second data shaping driver if the second data shaping driver has not been installed on the host, and disables the first flash memory and enables the second flash memory after the first data shaping driver has been installed to the host.

### CROSS REFERENCE TO RELATED APPLICATIONS

This Application claims the benefit of priority to Taiwan Patent Application No. 99146318, filed on Dec. 28, 2010, the entirety of which is incorporated by reference herein.

### BACKGROUND OF THE INVENTION

1. Field of the Invention

The invention relates to memories, and more particularly to flash memories.

2. Description of the Related Art

An ordinary data storage device comprises a controller and a flash memory and stores data for a host. When the host wants to store data to the data storage device, the host sends a write command to the data storage device, and the controller then writes data to the flash memory according to the write command. When the host wants to read data from the data storage device, the host sends a read command to the data storage device, and the controller then reads data from the flash memory and sends the data back to the host.

Flash memories are divided into single-level-cell (SLC) flash memories, multiple-level-cell (MLC) flash memories, and triple-level-cell (TLC) flash memories. A memory cell of an SLC flash memory can only store a single data bit. The SLC flash memory therefore has small data capacity, fast data access speeds, and long data retention periods. A memory cell of an MLC flash memory stores two data bits. A memory cell of a TLC flash memory can store three data bits. The TLC flash memory therefore has large data capacity, slow data access speeds, and short data retention periods.

To lower manufacturing costs of flash storage devices, MLC flash memories and TLC flash memories are preferred by manufacturers of the data storage devices, thereby increasing the data capacity of the data storage devices with limited costs. Because data retention periods of MLC flash memories and TLC flash memories are shorter than those of SLC flash memories, the data stored to the MLC flash memories and the TLC flash memories must be processed with a data shaping process. The data shaping process may be a scrambling process or a data interleaving process. A new-version controller is equipped with the function of the data shaping process to process the data to be written to the MLC flash memories and the TLC flash memories and to decode the data read from the MLC flash memories and the TLC flash memories.

An old-version controller, however, is not equipped with the data shaping function to process data to be written to the MLC flash memories and the TLC flash memories. The old-version controller therefore can only be used to control SLC flash memories. The old-version controller therefore cannot be used to control the MLC flash memories and the TLC flash memories. Data capacity of the data storage devices comprising the old-version controllers is therefore low. To increase data capacity of data storage devices comprising old-version controllers, a method for making a data storage device comprising an old-version controller, usable, to control a MLC flash memory or a TLC flash memory is therefore required.

### BRIEF SUMMARY OF THE INVENTION

The invention provides a data storage device. In one embodiment, the data storage device comprises a first flash memory, a second flash memory, and a controller. The first flash memory stores a first data shaping driver, wherein the first data shaping driver performs a data shaping function. The second flash memory stores user data. The controller enables the first flash memory and disables the second flash memory after the data storage device is turned on, detects whether a second data shaping driver has been installed on a host when the host is connected to the data storage device, installs the first data shaping driver to the host as the second data shaping driver if the second data shaping driver has not been installed on the host, and disables the first flash memory and enables the second flash memory after the first data shaping driver has been installed to the host.

The invention provides an operation method of a data storage device. In one embodiment, the data storage device comprises a first flash memory storing a first data shaping driver and a second flash memory storing user data, and the first data shaping driver performs a data shaping function. After the data storage device is turned on, the first flash memory is enabled and the second flash memory is disabled. When the host is connected to the data storage device, whether a second data shaping driver has been installed on a host is detected. If the second data shaping driver has not been installed on the host, the first data shaping driver is installed to the host as the second data shaping driver. After the first data shaping driver has been installed to the host, the first flash memory is disabled and the second flash memory is enabled.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a data storage device with a new-version controller;

FIG. 2 is a block diagram of a data storage device with an old-version controller according to the invention;

FIG. 3 is a flowchart of a method for installing a data shaping driver to a host according to the invention;

FIG. 4 is a flowchart of a method for writing data provided by a host to a data storage device according to the invention; and

FIG. 5 is a flowchart of a method for reading data from a data storage device according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

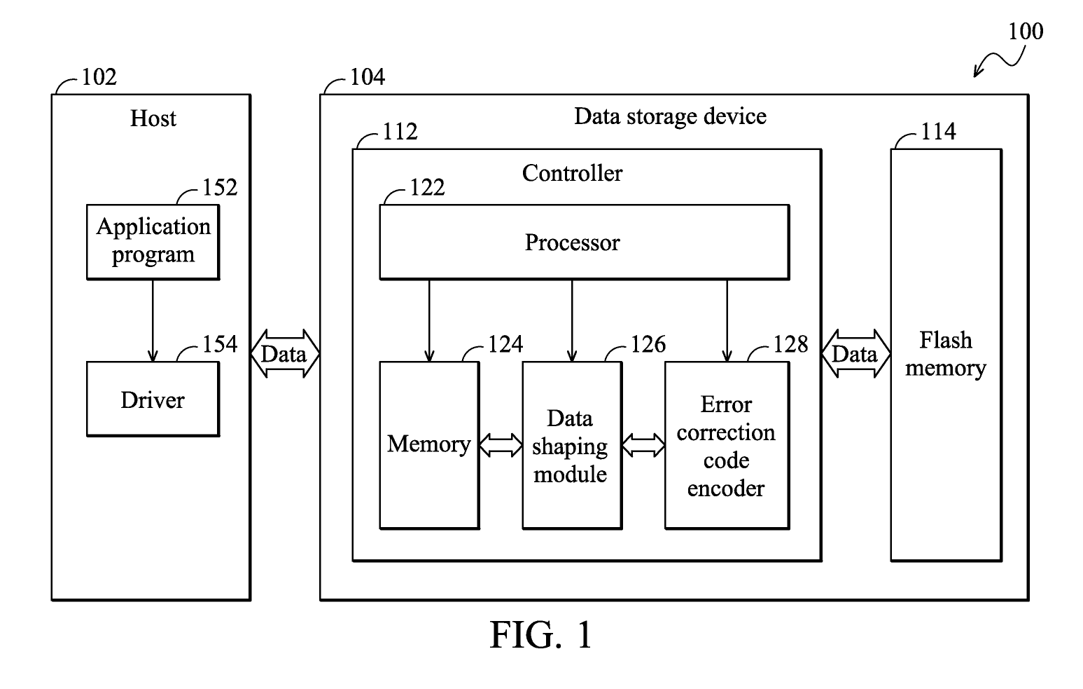

Referring to FIG. 1, a block diagram of a data storage device 104 with a new-version controller is shown. The data storage device 104 is coupled to a host 102 and comprises a controller 112 and a flash memory 114. The flash memory 114 is an MLC flash memory or a TLC flash memory. The controller 112 is a new-version controller and comprises a processor 122, a memory 124, a data shaping module 126, and an error correction code encoder 128. When the host 202 wants to write first write data to the data storage device 104, the host 202 sends the first write data to the data storage device 104. The controller 112 then stores the first write data in the memory 124. The data shaping module 126 then converts the first write data to second write data according to a data shaping process. The error correction code encoder 128 then encodes third write data according to the second write data. The controller 112 then writes the third write data to the flash memory 114. Because the third write data has been processed by the data shaping module 126, the data retention period of the third write data is lengthened, and an error rate of the third write data is therefore reduced.

When the host 102 wants to read third read-out data from the data storage device 104, the controller 112 first reads first read-out data from the flash memory 114. The error correction code encoder 128 then decodes the first read-out data to obtain second read-out data. The data shaping module 126 then converts the second read-out data to the third read-out data according to an inverse data shaping process. The controller 112 then sends the third read-out data to the host 102.

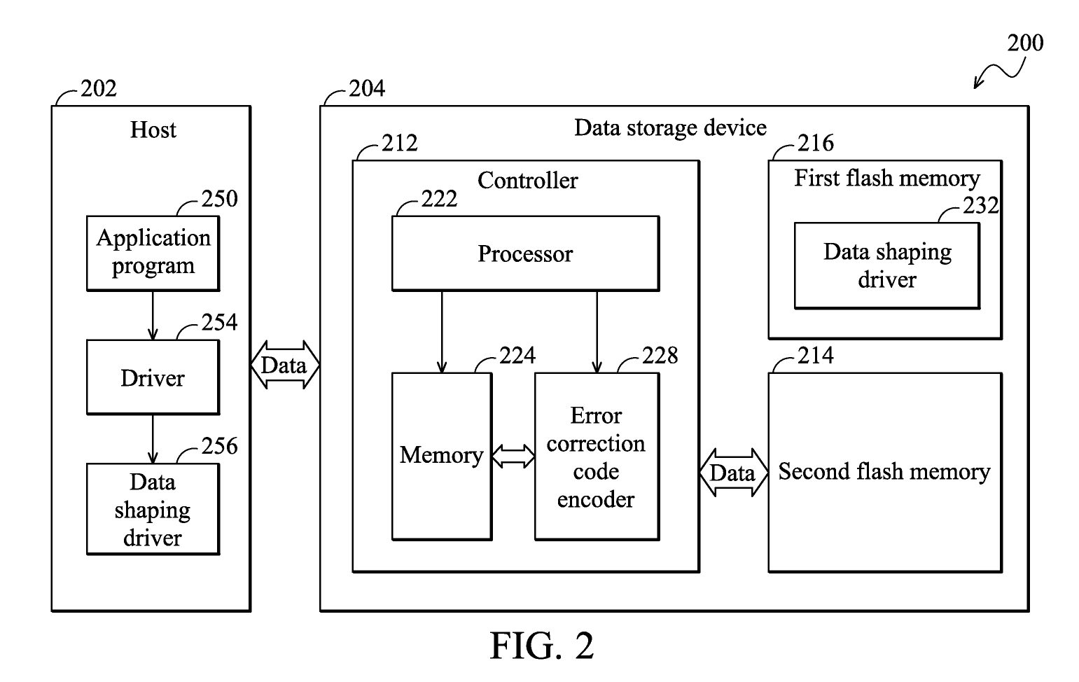

Referring to FIG. 2, a block diagram of a data storage device 204 with an old-version controller according to the invention is shown. The data storage device 204 comprises a controller 212, a first flash memory 216, and a second flash memory 214. The first flash memory 216 is a single-level-cell (SLC) flash memory and stores a data shaping driver 232. The data shaping driver 232 has a data shaping function. In one embodiment, the data shaping function is a data scrambling function. In another embodiment, the data shaping function is a data interleaving function. In one embodiment, the data format of the first flash memory 216 is a CD-ROM format, and the data shaping driver 232 stored in the first flash memory 216 has an auto-run function and is automatically executed when the data storage device 204 is connected to the host 202. The second flash memory 214 is a multi-level-cell (MLC) flash memory or a triple-level-cell (TLC) flash memory and is used to store user data. The controller 212 is an old-version controller and does not have a data shaping function. In one embodiment, the controller 212 comprises a memory 224 and an error correction code encoder 228.

Although the controller 212 of the data storage device 204 does not have a data shaping function, and the second flash memory 214 storing user data is an MLC flash memory or a TLC flash memory, the controller 212 can still write data obtained from the host into the second flash memory 214. When the data storage device 204 is connected to the host 202, the controller 212 detects whether a data shaping driver 256 has been installed on the host 202. If there is no data shaping driver 256 installed on the host 202, the controller 212 of the data storage device 204 automatically installs the data shaping driver 232 stored in the first flash memory 232 to the host 202 as the data shaping driver 256. After the data shaping driver 256 has been installed on the host 202, when the host 202 wants to write original data to the data storage device 204, the data shaping driver 256 processes the original data according to the data shaping function to obtain processed data, and sends the processed data to the data storage device 204. The controller 212 then writes the processed data to the second flash memory 214, and the processed data stored in the second flash memory 214 therefore has a long data retention period due to the data shaping processing. When the host 202 wants to read the processed data from the data storage device 204, after the host 202 receives the processed data from the data storage device 204, the data shaping driver 256 recovers the original data from the processed data according to am inverse data shaping function. The host 202 can then use the recovered original data.

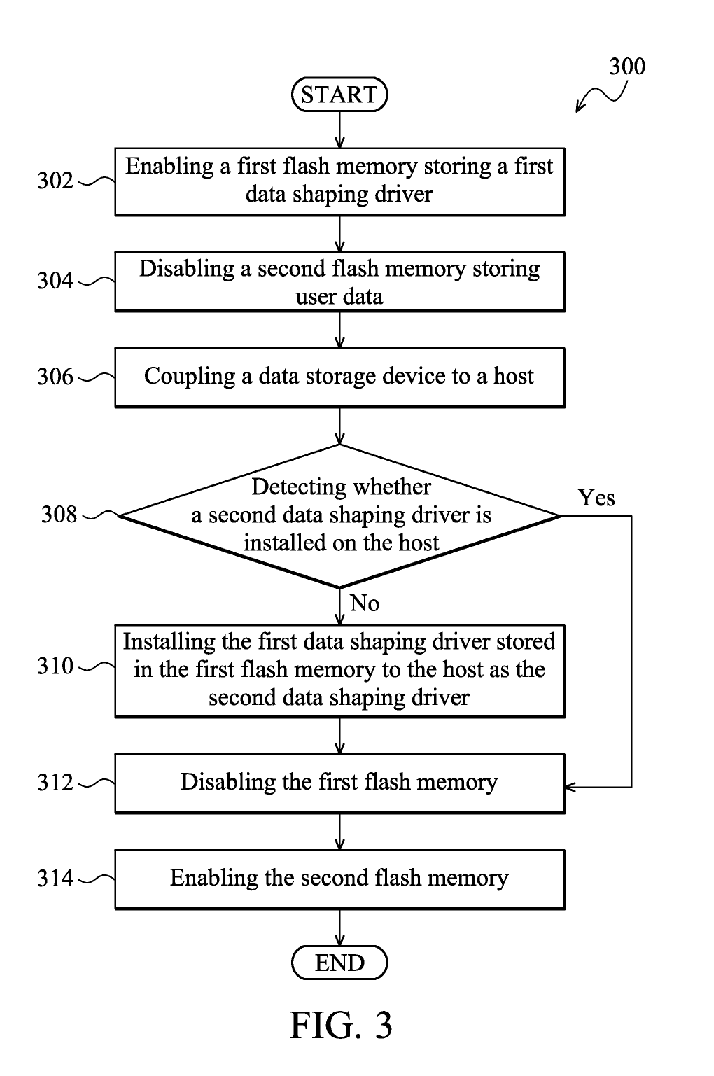

Referring to FIG. 3, a flowchart of a method 300 for installing the data shaping driver 232 to the host 202 according to the invention is shown. First, when the data storage device 204 is turned on, the controller 212 enables the first flash memory 216 storing the data shaping driver 232 (step 302), and disables the second flash memory 214 storing user data (step 304). The data storage device 204 is then connected to the host 202 (step 306). When the data storage device 204 is connected to the host 202, because the second flash memory 214 is disabled, the host 202 can only detect the first flash memory 216 with the CD-ROM data format in the data storage device 216 and therefore takes the data storage device 204 as a CR-ROM. Because the data shaping driver 216 stored in the first flash memory 216 has an auto-run function, the data shaping driver 216 is then automatically executed. The controller 212 then detects whether a data shaping driver 256 has been installed on the host 202 (step 308).

If the data shaping driver 256 has not been installed on the host 202, the controller 212 reads the data shaping driver 232 from the first flash memory 216, and installs the data shaping driver 232 to the host 202 as the data shaping driver 256 (step 310). If the data shaping driver 256 has been installed on the host 202, the controller 212 does not install the data shaping driver 232 to the host 202. The controller 212 then disables the first flash memory 216 (step 312), and enables the second flash memory 214 (step 314). The host 202 can only detect the second flash memory 214 for user data storage in the data storage device 204, and therefore takes the device 204 as a data storage device.

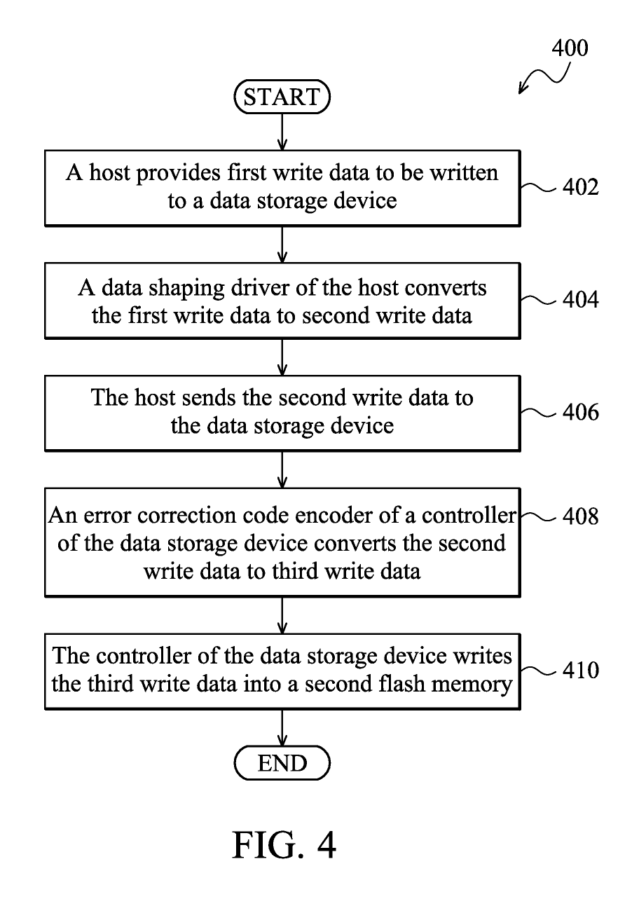

Referring to FIG. 4, a flowchart of a method 400 for writing data provided by the host 202 to the data storage device 204 according to the invention is shown. First, the host 202 generates first write data to be written to the data storage device 204 (step 402). The data shaping driver 256 of the host 202 then converts the first write data to second write data according to a data shaping function (step 404). In one embodiment, the data shaping function is a data scrambling function or a data interleaving function. The host 202 then sends the second write data to the data storage device 204 (step 406). After the data storage device 204 receives the second write data, the controller 212 first stores the second write data in the memory 224. The error correction code encoder 228 then encodes third write data according to the second write data (step 408). The controller 212 then writes the third write data to the second flash memory 214 (step 410). Although the controller 212 does not have a data shaping function, because the third write data written to the second flash memory 214 has been processed by the data shaping driver 256 according to a data shaping function, the data retention period of the third write data stored in the second flash memory 214 is lengthened.

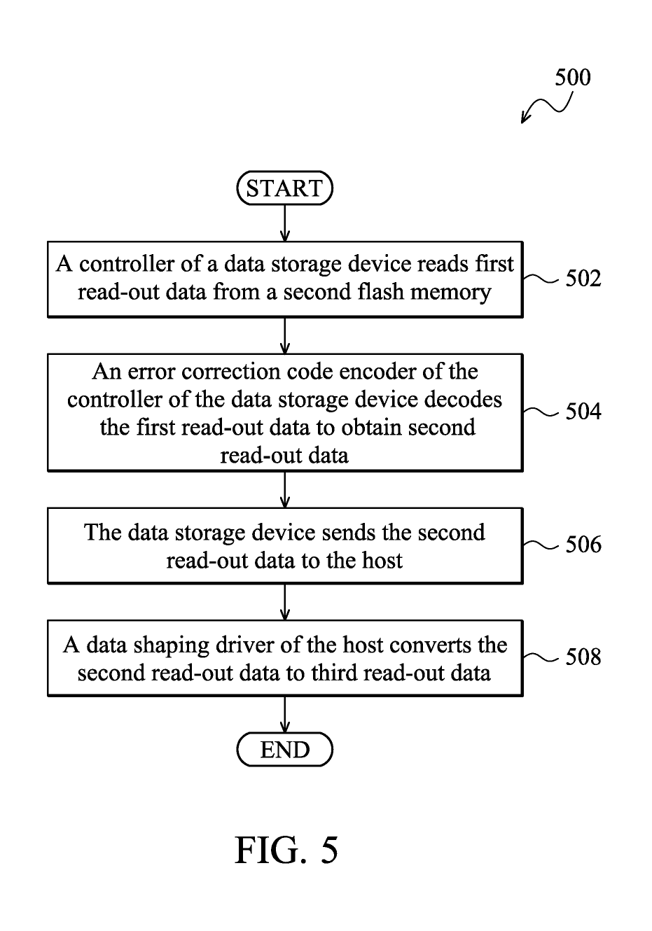

Referring to FIG. 5, a flowchart of a method 500 for reading data from the data storage device 204 according to the invention is shown. First, the controller 212 of the data storage device 204 reads first read-out data from the second flash memory 214 (step 502). The error correction code encoder 228 of the controller 212 then decodes the first read-out data to obtain second read-out data (step 504). The controller 212 then stores the second read-out data in the memory 224. The data storage device 204 then sends the second read-out data to the host 202 (step 506). After the host 202 receives the second read-out data, the data shaping driver 256 of the host 202 recovers third read-out data from the second read-out data according an inverse data shaping function (step 508). In one embodiment, the inverse data shaping function is a de-interleaving function or a de-scrambling function.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a first flash memory, for storing a first data shaping driver, wherein the first data shaping driver performs a data shaping function;
a second flash memory, for storing user data; and
a controller, enabling the first flash memory and disabling the second flash memory after the data storage device is turned on, detecting whether a second data shaping driver has been installed on a host when the host is connected to the data storage device, installing the first data shaping driver to the host as the second data shaping driver if the second data shaping driver has not been installed on the host, and disabling the first flash memory and enabling the second flash memory after the first data shaping driver has been installed to the host.

2. The data storage device as claimed in claim 1, wherein the first flash memory is a single-level-cell (SLC) flash memory, and the second flash memory is a triple-level-cell (TLC) flash memory.

3. The data storage device as claimed in claim 1, wherein the data format of the first flash memory is a CD-ROM format.

4. The data storage device as claimed in claim 3, wherein the first data shaping driver stored in the first flash memory has an auto-run function and is automatically executed when the data storage device is coupled to the host.

5. The data storage device as claimed in claim 1, wherein the data shaping function is a data scrambling function or a data interleaving function, and the controller does not have the data shaping function.

6. The data storage device as claimed in claim 1, wherein when the host wants converts the first write data to second write data and transmits the second write data to the data storage device, and an error correction code encoder of the controller encodes third write data according to the second write data and writes the third write data to the second flash memory.

7. The data storage device as claimed in claim 1, wherein when the host wants to read third read-out data from the data storage device, the controller reads first read-out data from the second flash memory, an error correction code encoder of the controller decodes the first read-out data to obtain second read-out data and transmits the second read-out data to the host, and the second data shaping driver converts the second read-out data to the third read-out data.

8. An operation method of a data storage device, wherein the data storage device comprises a first flash memory storing a first data shaping driver and a second flash memory storing user data, and the first data shaping driver performs a data shaping function, the operation method comprising:
after the data storage device is turned on, enabling the first flash memory and disabling the second flash memory;
when the host is connected to the data storage device, detecting whether a second data shaping driver has been installed on a host;
if the second data shaping driver has not been installed on the host, installing the first data shaping driver to the host as the second data shaping driver; and
after the first data shaping driver has been installed to the host, disabling the first flash memory and enabling the second flash memory.

9. The operation method as claimed in claim 8, wherein the first flash memory is a single-level-cell (SLC) flash memory, and the second flash memory is a triple-level-cell (TLC) flash memory.

10. The operation method as claimed in claim 8, wherein the data format of

11. The operation method as claimed in claim 10, wherein the first data shaping driver stored in the first flash memory has an auto-run function and is automatically executed when the data storage device is coupled to the host.

12. The operation method as claimed in claim 8, wherein the data shaping function is a data scrambling function or a data interleaving function.

13. The operation method as claimed in claim 8, wherein the operation method further comprises:
when the host wants to write first write data to the data storage device, converting the first write data to second write data with the second data shaping driver;
transmitting the second write data from the host to the data storage device;
encoding third write data according to the second write data with an error correction code encoder; and
writing the third write data to the second flash memory.

14. The operation method as claimed in claim 8, wherein the operation method further comprises:
when the host wants to read third read-out data from the data storage device, reading first read-out data from the second flash memory;
decoding the first read-out data to obtain second read-out data with an error correction code encoder;
transmitting the second read-out data to the host; and
converting the second read-out data to the third read-out data with the second data shaping driver.
